(19) United States
(12) Patent Application Publication
(10) Pub. No.: US 2025/0160314 A1
(43) Pub. Date: May 22, 2025

(54) INSECT-REPELLING LIGHT AND FAN

(71) Applicant: twopoint0 LLC, Richmond, VA (US)

(72) Inventor: Martin Maggio, Dubai Marina (AE)

(21) Appl. No.: 18/511,894

(22) Filed: Nov. 16, 2023

(51) Int. Cl. A01M 29/10

(52) U.S. Cl. CPC A01M 29/10

(57) ABSTRACT

An insect repellant apparatus includes a base and a number of light sources coupled to the base. The insect repellant apparatus includes a controller configured to vary a current flow to each light source of the number of light sources. The apparatus includes a translucent body coupled to the base at a first end of the body and shaped to fit around the number of light sources. The apparatus includes a motor coupled to the body at a second end of the body opposite to the first end and rotatable with respect to the body. The apparatus includes a hub coupled to the motor. The hub includes a number of openings configured to receive ends of blades.

### FIELD

This disclosure relates generally to insect repelling and more particularly to insect-repelling light and fan apparatuses, systems, and methods of manufacture.

### BACKGROUND

Insect-repelling systems and apparatuses can help to encourage insects to evacuate a certain area. For example, insect-repelling devices may be used in homes, dining areas, retail stores, or outdoor settings.

### SUMMARY

The subject matter of the present application has been developed in response to the present state of the art, and in particular, in response to the shortcomings of insect-repelling apparatuses that have not yet been fully solved by currently available techniques. Accordingly, the subject matter of the present application has been developed to provide insect-repelling apparatuses that overcome at least some of the above-discussed shortcomings of prior art techniques.

Examples of the present disclosure include an insect repellent apparatus includes a base and a light source coupled to the base. The insect repellent apparatus includes a controller configured to vary a current flow to the light source and a translucent body coupled to the base at a first end of the body and shaped to fit around the light source. The apparatus includes a motor coupled to the body at a second end of the body opposite to the first end and rotatable with respect to the body. The apparatus includes a hub coupled to the motor. The hub includes a number of openings configured to receive ends of blades.

Examples of the present disclosure include a base and a light source coupled to the base. The system includes a controller configured to vary a current flow to the light source and a translucent body coupled to the base at a first end of the body and shaped to fit around the light source. The system includes a motor coupled to the body at a second end of the body opposite to the first end and rotatable with respect to the body. The system includes a hub coupled to the motor. The hub includes a number of openings configured to receive ends of blades. The system includes a number of blades. Each blade of the number of blades includes a first end configured to be removably received by an opening of the number of openings.

Examples of the present disclosure include a method of manufacturing an insect repellant apparatus. The method includes coupling a light source to a base, configuring a controller to vary a current flow to the light source, and coupling a translucent body to the base around the light source at a first end of the translucent body. The method also includes coupling a motor to the body at a second end of the body opposite to the first end of the body such that the motor is rotatable with respect to the body about an axis substantially perpendicular to the base. The method includes forming a number of openings configured to receive ends of blades in a hub and coupling the hub to the motor.

The described features, structures, advantages, and/or characteristics of the subject matter of the present disclosure may be combined in any suitable manner in one or more examples and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example or implementation. In other instances, additional features and advantages may be recognized in certain examples and/or implementations that may not be present in all examples or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific examples that are illustrated in the appended drawings. Understanding that these drawings, which are not necessarily drawn to scale, depict only certain examples of the subject matter and are not therefore to be considered to be limiting of its scope, the subject matter will be described and explained with additional specificity and detail through the use of the drawings, in which:

FIG. 1A is a perspective view of a system for repelling insects, according to one or more examples of the present disclosure;

FIG. 1B is a front view of a system for repelling insects, according to one or more examples of the present disclosure;

FIG. 1C is a bottom view of a system for repelling insects, according to one or more examples of the present disclosure;

FIG. 1D is an exploded view of a system for repelling insects, according to one or more examples of the present disclosure;

FIG. 1E is a close-up view of a light source of a system for repelling insects, according to one or more examples of the present disclosure;

FIG. 1F is a close-up view of a blade of a system for repelling insects, according to one or more examples of the present disclosure;

FIG. 1G is a close-up view two sections of a blade of a system for repelling insects, according to one or more examples of the present disclosure;

FIG. 2A is a perspective view of an apparatus for repelling insects, according to one or more examples of the present disclosure;

FIG. 2B is a close-up view of a hub of an apparatus for repelling insects, according to one or more examples of the present disclosure;

FIG. 3 is an exploded view of a system for repelling insects having a light source emitting light of varying intensity, according to one or more examples of the present disclosure;

FIG. 4 is a schematic diagram of a controller of an apparatus for repelling insects, according to one or more examples of the present disclosure; and

FIG. 5 is a schematic flow chart of a method of manufacturing an apparatus for repelling insects, according to one or more examples of the present disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure, however, absent an express correlation to indicate otherwise, an implementation may be associated with one or more examples.

The following is a non-exhaustive list of examples, which may or may not be claimed, of the subject matter, disclosed herein.

The following portion of this paragraph delineates example 1 of the subject matter, disclosed herein. According to example 1, an insect repellant apparatus includes a base and a number of light sources coupled to the base. The insect repellant apparatus includes a controller configured to vary a current flow to each light source of the number of light sources. The apparatus includes a translucent body coupled to the base at a first end of the body and shaped to fit around the number of light sources. The apparatus includes a motor coupled to the body at a second end of the body opposite to the first end and rotatable with respect to the body. The apparatus includes a hub coupled to the motor. The hub includes a number of openings configured to receive ends of blades.

The following portion of this paragraph delineates example 2 of the subject matter, disclosed herein. According to example 2, which encompasses example 1, above, the number of light sources include rows of light sources. The controller varying the current flow to the number of light sources includes providing a first level of current flow to a first row of the rows and providing a second level of current flow different from the first level to a second row of the rows.

The following portion of this paragraph delineates example 3 of the subject matter, disclosed herein. According to example 3, which encompasses example 1 or 2, above, the motor is configured to rotate simultaneously with the light source emitting light.

The following portion of this paragraph delineates example 4 of the subject matter, disclosed herein. According to example 4, which encompasses any one of examples 1-3, above, the controller is configured to vary the current flow cyclically.

The following portion of this paragraph delineates example 5 of the subject matter, disclosed herein. According to example 5, which encompasses any one of examples 1-4, above, the controller is further configured to adjust a rotations per minute (“RPM”) of the hub via the motor.

The following portion of this paragraph delineates example 6 of the subject matter, disclosed herein. According to example 6, which encompasses any one of examples 1-5, above, the light source is configured to emit light having a wavelength of not less than 560 nanometers (“nm”) and not greater than 700 nm.

The following portion of this paragraph delineates example 7 of the subject matter, disclosed herein. According to example 7, which encompasses any one of examples 1-6, above, a light source of the number of light sources includes a light-emitting diode (“LED”).

The following portion of this paragraph delineates example 8 of the subject matter, disclosed herein. According to example 8, which encompasses any one of examples 1-7, above, the body has a first width at the first end and a second width at the second end that is less than the first width.

The following portion of this paragraph delineates example 9 of the subject matter, disclosed herein. According to example 9, which encompasses any one of examples 1-8, above, the base includes a self-balancing base.

The following portion of this paragraph delineates example 10 of the subject matter, disclosed herein. According to example 10, which encompasses any one of examples 1-9, above, each of the motor and the hub are rotatable with respect to the body about an axis that is substantially perpendicular to the base.

The following portion of this paragraph delineates example 11 of the subject matter, disclosed herein. According to example 11, which encompasses any one of examples 1-10, above, the motor is configured to rotate at an RPM of not less than 270 and not greater than 1350.

The following portion of this paragraph delineates example 12 of the subject matter, disclosed herein. According to example 12, a system includes a base and a number of light sources coupled to the base. The system includes a controller configured to vary a current flow to each light source of the number of light sources and a translucent body coupled to the base at a first end of the body and shaped to fit around the number of light sources. The system includes a motor coupled to the body at a second end of the body opposite to the first end and rotatable with respect to the body about an axis substantially perpendicular to the base. The system includes a hub coupled to the motor. The hub includes a number of openings. The system includes a number of blades. Each blade of the number of blades includes a first end configured to be removably received by an opening of the number of openings.

The following portion of this paragraph delineates example 13 of the subject matter, disclosed herein. According to example 13, which encompasses example 12, above, each blade of the number of blades includes a coating of holographic material.

The following portion of this paragraph delineates example 14 of the subject matter, disclosed herein. According to example 14, which encompasses examples 12-13, above, each of the number of blades includes a first section that includes the first end. Each blade of the number of blades also includes a second section removably attachable to the first section at a second end of the first section opposite to the first end.

The following portion of this paragraph delineates example 15 of the subject matter, disclosed herein. According to example 15, which encompasses examples 12-14, above, the second section is removably attachable to the first section via one or more openings in the first section.

The following portion of this paragraph delineates example 16 of the subject matter, disclosed herein. According to example 16, which encompasses examples 12-15, above, the controller is further configured to cyclically vary the current flow over cycles of not less than 0.25 and not greater than 5 seconds in duration.

The following portion of this paragraph delineates example 17 of the subject matter, disclosed herein. According to example 17, which encompasses any of examples 12-16, above, a ratio of a maximum circumference of the hub to a maximum circumference of the base is between 1 to 70 and 1 to 100.

The following portion of this paragraph delineates example 18 of the subject matter, disclosed herein. According to example 18, which encompasses any of examples 12-17, above, the system includes a handle attached to and configured to rotate about an axis coplanar with and a first side of the base opposite to a second side of the base. The number of light sources are coupled to the second side of the base.

The following portion of this paragraph delineates example 19 of the subject matter, disclosed herein. According to example 19, a method of manufacturing an insect replant apparatus includes coupling a number of light sources to a base, configuring a controller to vary a current flow to each light source of the number of light sources, and coupling a translucent body to the base around the number of light sources at a first end of the translucent body. The method also includes coupling a motor to the body at a second end of the body opposite to the first end of the body such that the motor is rotatable with respect to the body about an axis substantially perpendicular to the base. The method includes forming a number of openings configured to receive ends of blades in a hub and coupling the hub to the motor.

The following portion of this paragraph delineates example 20 of the subject matter disclosed herein. According to example 20, which includes example 19, coupling the number of light sources to the base includes coupling the number of light sources to a support such that the number of light sources are arranged in rows and coupling the support to the base.

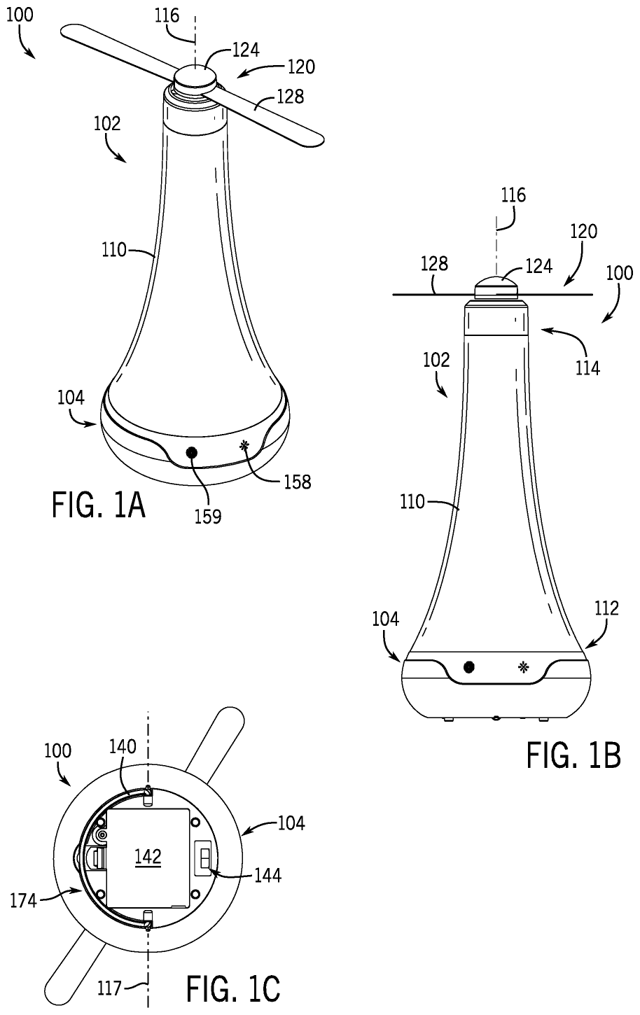

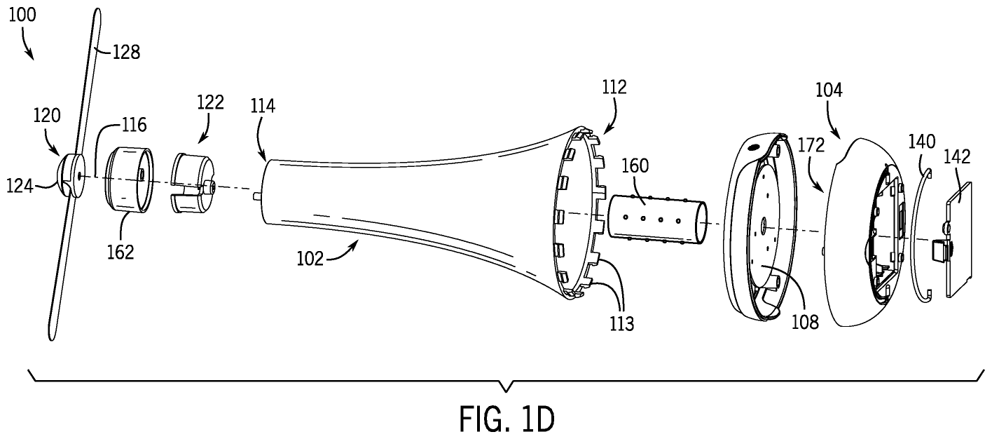

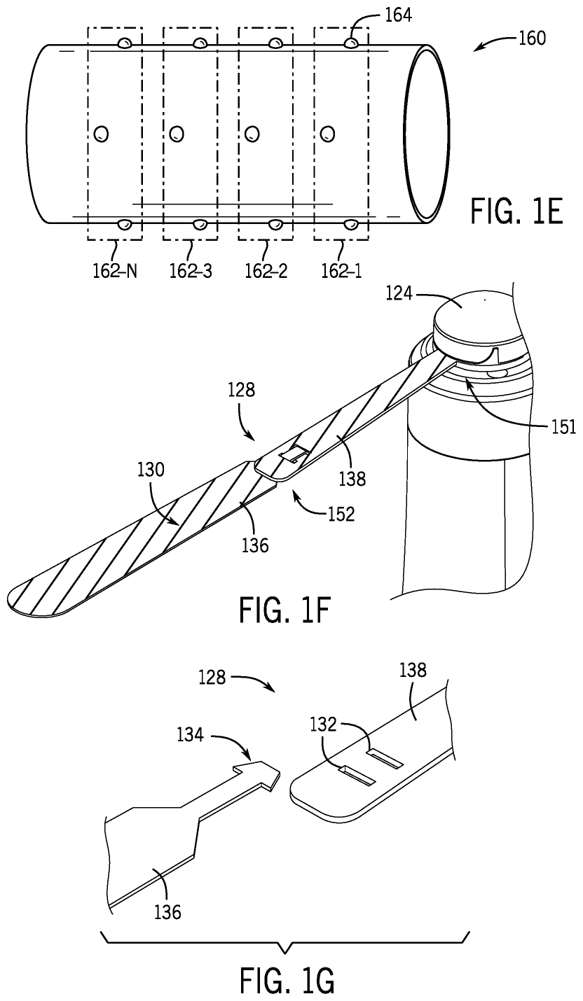

FIG. 1A is a perspective view of a system 100 for repelling insects, according to one or more examples of the present disclosure. As shown in FIG. 1A, the system 100 includes an insect-repelling apparatus 102 and a number of fan blades 128. The insect-repelling apparatus 102 includes a base 104, a body 110, and a hub 124. As shown in FIG. 1D, the apparatus 102 also includes a light component 160 and a motor 122, each of which, in some examples, are controlled by a controller 108. The controller 108, in some examples, is in communication with one or both of the light component 160 and the motor 122 and is configured to actuate turning on one or both of the light component 160 and the motor 122 (e.g., in response to user input via a button 159 and/or a switch 144).

In some examples, the light component 160 is coupled to the base 104 such that the light component 160 is surrounded by the body 110 of the apparatus 102. As shown in FIG. 1D, in some examples, the light component 160 includes a support 161, with a number of light sources 164 coupled to the support 161. In some examples, the light sources 164 are LEDs.

In some examples, the apparatus 102 is configured to create a flickering effect by cyclically supplying current to rows 162-1, . . . , 162-N (referred to herein, individually and/or collectively, as “162”) of light sources 164 shown in FIG. 1E. In some examples, the controller 108 causes the light sources 164 to be powered on and off in a light-emitting cycle that simulates the effects of a flickering candle. For example, each of the rows 162 are powered off initially and/or receive a minimum current flow to emit a low-intensity light. The apparatus 102 first supplies current to a first row 162-1, subsequently to a second row 162-2, to a third row 162-3, and so forth until all rows 162 are emitting light. Then, the apparatus 102 decreases the flow of current to the last row 162-N to receive current, then decreases the flow of current to an adjacent row 163-3, and so forth until all but a small number and/or all of the rows 162 are not emitting light. In some examples, the LEDs 164 are not completely powered off and are instead dimmed to a lower level of light emission. For example, the current supplied to the LEDs 164 varies from a minimum current to a maximum current throughout the cycle.

In some examples, the apparatus 102 provides current to the rows 162 non-sequentially. For example, the apparatus 102 provides current to the rows 162 in a randomized manner. In some examples, the apparatus 102 is configured to repeat a cycle of non-sequentially illuminating the rows 162. For example, one cycle includes supplying a maximum current to a first row 162-1, a third row 162-3 not adjacent to the first row 162-1, a fourth row 162-N, and then to a second row 162-2. In such examples, while one row 162 is at a maximum current, the remaining rows 162 maintain a minimum current.

In some examples, the minimum current is not greater than 5 milli-amperes (“mA”). In some examples, the maximum current is not less than 15 mA and not greater than 35 mA. In some examples, the time interval of the cycle is not less than 0.25 seconds and not greater than 6 seconds. In some examples, the light component 160 cycles from a minimum intensity, to a maximum intensity, and back to a minimum intensity throughout the time period of the cycle. In some examples, the minimum intensity is greater than 0 and not greater than 5 millicandela (“mcd”). In some examples, the maximum intensity is not less than 20 mcd and not greater than 100 mcd.

In some examples, the cycle of providing current to the light sources 164 is repeated until the apparatus 102 receives user input to stop the cycling. For example, the cycles of variation of current to the rows 162 of the light component 160 continue until a user has switched an apparatus 102 (e.g., via a switch) to a different mode or powered the apparatus 102 off.

In some examples, the support 161 is substantially circular. In some examples, each row 162 extends along a perimeter of the support 161 such that the light emitted by the light sources 164 is visible from all angles surrounding the apparatus 102. In some examples, each row 162 is equidistant from each other. In some examples, light sources 164 of a given row 162 are equidistant from each other in the row 162.

In some examples, the light component 160 is configured to emit light having a wavelength to deter insects. For example, the light component 160 is configured to emit yellow light, pink light, or orange light. In some examples, the light component 160 is configured to emit light having a wavelength of not less than 560 nanometers (“nm”) and not greater than 700 nm. In some examples, the light component 160 is configured to emit light having a wavelength of not less than 565 nm and not greater than 625 nm.

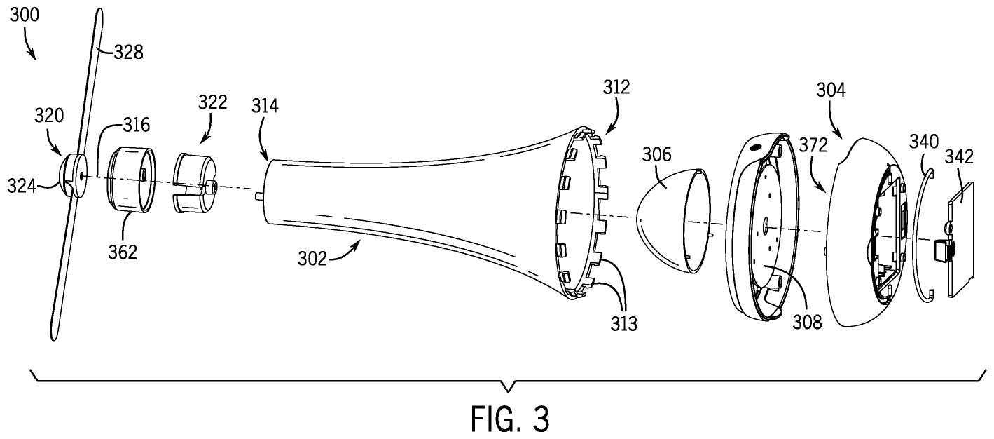

In some examples, as shown in FIG. 3, an insect-repelling system 300 includes a light source coupled to the base 304. In some examples, the light source includes a lens 306 coupled to the base 304. In some examples, the system 300 includes only a single light source. In some examples, the apparatus 102 creates a flickering light effect by varying the current supplied to the light source. For example, the controller 308 cyclically varies current to the light source to cause the intensity of emitted light to increase continuously to a peak during a first part of the cycle and decrease continuously from the peak during a second part of the cycle.

In some examples, a flickering light effect is accomplished via a dimmer switch. In some examples, the controller 308 includes a frequency modulator that varies the frequency of an electric signal fed to the light source in order to accomplish the flickering effect. In some examples, the controller 308 includes a pulse width modulation (“PWM”) controller and accomplishes a flickering effect by turning the power to the light source on and off.

In some examples, the body 110 of the apparatus 102 is translucent. As such, at least some light emitted from the light component 160 is visible through the body 110. As such, insects external to the body 110 perceive light emitted from the light component 160 and are repelled by the light. As used herein, the term “translucent body” includes a body that allows at least some light to pass through. In some examples, the translucent body 110 is also completely transparent. In other examples, the translucent body 110 is made of a material that permits the passage of light through the translucent body 110 but diffuses that light such that the interior of the body is obscured from the perspective of the exterior. In some examples, on scale of 0 to 1, with 0 being completely opaque and 1 being completely transparent, the material of the translucent body 110 has a translucency between and inclusive of 2 and 8. In some examples, the body 110 is coupled to the base 104 at a first end 112 of the body 110.

In some examples, a center line of the light component 160 is the axis of rotation 116 of the fan 120 and/or is parallel to the axis of rotation 116 of the fan 120. In some examples, the body 110 is shaped to fit around the light component 160. As such, the body 110 has a width that is greater than the width of the light component 160. In some examples, the body 110 has a number of protrusions 113 at the first end 112 that are configured to mate with a number of slots in the base 104. In other examples, one of the body 110 and the base 104 include threaded portions to help secure the body 110 to the base 104.

In some examples, the system 100 includes a fan 120 coupled to the body 110 at a second end 114 of the body 110 opposite to the first end 112. The fan 120 includes a motor 122, a hub 124, and a number of fan blades 128. The motor 122 is fixed with respect to the hub 124, and each of the hub 124 and the motor 122 rotate together about an axis 116 that is substantially perpendicular to the base 104. In some examples, the axis 116 is a center line of at least one of the body 110, the hub 124, and the motor 122. In some examples, the motor 122 is battery-powered. In other examples, the motor 122 is powered by an electrical connection of the apparatus 102 to a power supply.

In some examples, the motor 122 and the hub 124 are rotatable with respect to the body 110. As such, in some examples, the motor 122 and the hub 124 are rotatably coupled to the body 110. In other examples, the body 110 is fixed to the motor 122 and the hub 124 and rotates with the motor 122 and the hub 124. In such examples, the body 110 rotates with respect to the base 104.

As shown in FIG. 1A, the fan 120 includes fan blades 128. Although two fan blades 128 are shown in FIG. 1A, examples of the present disclosure are not so limited. For example, examples of the present disclosure include fans 120 with more than two fan blades 128. Although substantially straight, longitudinal fan blades 128 extending laterally from the hub 124 in a direction substantially perpendicular to the axis 116 are shown in FIG. 1A, examples of the present disclosure are not so limited. In some examples, the fan blades 128 are curved. In other examples, the hub 124 is not concentric with the axis 116, and the fan blades 128 extend at an angle of between 0 and 90 degrees with respect to the axis 116.

In some examples, the motor 122 is configured to rotate simultaneously with the light component 160 emitting light. In some examples, the motor 122 is configured to rotate during a cycle of the light component 160 emitting light at different intensities. As such, the apparatus 102 is configured to simultaneously produce a flickering light effect while running the fan 120.

As used herein, the term “substantially perpendicular” refers to an angle of not less than 80 degrees and not greater than 100 degrees. For example, in some examples, the axis 116 of rotation of the fan 120 is substantially perpendicular to the base 104 and/or substantially perpendicular to a surface on which the base 104 is configured to rest. In such examples, at least one of the angle between the axis 116 and a plane of the base 104 and the angle between the axis 116 and a surface on which the base 104 rests is not less than 80 degrees and not greater than 100 degrees.

In some examples, the controller 108 controls the speed of the motor 122. For example, the controller 108 is configured actuate adjusting a rotations per minute (“RPM”) of the hub 124 via the motor 122. In some examples, the fan 120 is configured to rotate at an RPM of not less than 270 and not greater than 1350. In some examples, the controller 108 adjusts the RPM based on user input. For example, although not shown, in some examples, the apparatus 102 includes a number of elements on the body 110 and/or the base 104 through which the user can provide input. For example, the apparatus 102 includes a number of buttons 158, knobs, user interfaces, or keypads for receiving input for adjusting RPMs of the fan 120. In some examples, the apparatus 102 is configured to connect with a computing device of a user (e.g., via a Wi-Fi or Bluetooth connection). Examples of the present disclosure include an application accessed by the user via their computing device (e.g., a mobile application accessed via the mobile device). In some examples, the user provides input for the controller 108 to adjust the RPMs of the fan 120 and/or to adjust properties of the light source via the application. For example, the user instructs the controller 108 to change the light component 160 from a “Flickering” mode to a “Steady State” mode, and the controller 108 responds by allowing a steady current draw from the light component 160 rather than varying the current to the light component 160.

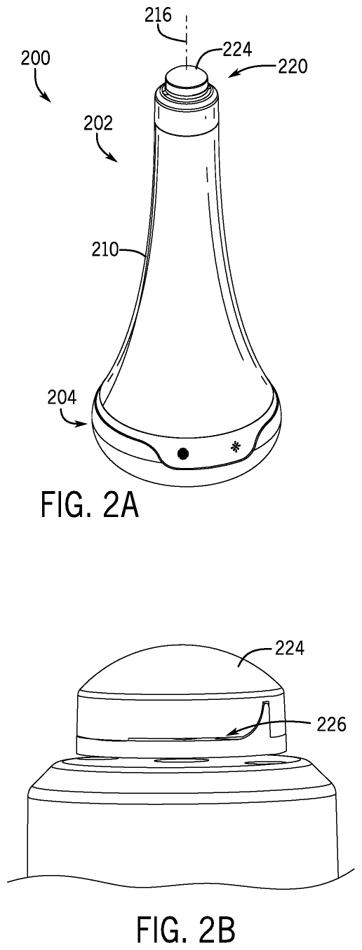

In some examples, the fan blades 128 are removable from the hub 124. For example, the fan blades 128 are removed from the hub 124 without removing the hub 124 from the body 110. For example, FIG. 2A is a perspective view of an apparatus 202, which is an example of the apparatus 102 with the fan blades 128 removed. FIG. 2B shows a close-up view of the hub 224, which is an example of the hub 124. As shown in FIG. 2B, the hub 224 includes a number of openings 226. Each opening 226 is configured to receive an end 151 of a fan blade 128. The end 151 of the fan blade 128 is configured to be removably received by the opening 226.

In some examples, the blades 128 are expandable. FIG. 1F is a close-up view of a blade 128 of the system 100, according to one or more examples of the present disclosure. As shown in FIG. 1F, the blade 128 includes two sections, a first section 138 and a second section 136. As shown in FIG. 1F, the two sections 136 and 138 are joined together to form the blade 128. The first section 138 includes the first end 151 of the blade, which is received by the opening 126 in the hub 124. The first section 138 extends laterally outward from the hub.

FIG. 1G is a close-up view of the two sections 136 and 138, according to one or more examples of the present disclosure. FIG. 1G shows the second section 136 removed from the first section 138. As shown in FIGS. 1F and 1G, the second section 136 is removably attachable to the first section 138 at a second end 152 of the first section 138, which is opposite to the first end 151 of the first section 138.

For example, as shown in FIG. 1G, the second section 136 includes an end 134 that is configured to fit into one or more openings 132 in the first section 138. In some examples, the openings 132 intersect and extend through a thickness of the first section 138. However, in other examples, the first section 138 includes a slot at the second end 152 to receive the end 134 of the second section 136 (for example, in a similar fashion as the opening 126 receives the end 151 of the blade 128). In some examples, the second section end 134 includes a portion configured to mate with the second first-section end 152.

In some examples, the second section end 134 is sufficiently flexible to allow it to be threaded through each of two openings 132 in the first section 138, thus securing the second section 136 to the first section 138. Although two sections 136 and 138 of the blades 128 are shown in FIGS. 1F and 1G, examples of the present disclosure are not so limited. For example, the blade 128 includes three or more sections that are removably attached to each other help increase customizability of blade 128 length.

In some examples, at least one of the blades 128 is coated with a material 130. For example, the material 130 is a holographic material. In some examples, the material 130 includes one or more of: paint, spandex, nylon, cotton, foil, statin, satin, organza, holographic film, polyester, or any combination thereof. In some examples, the material 130 is a tangible layer of the fan blade 128. In other examples, the material 130 includes dye or paint on the fan blade 128. The material 130 gives off a shiny appearance. In some examples, the material 130 is micro-embossed with patterns, images, or designs. In some examples, the material 130 is configured to reflect light from the fan blades 128 in a manner that is disorienting, dizzying, and/or repelling of insects. In some examples, the holographic material 130 is configured to reflect light off the blades 128 in the wavelength range of not less than 560 nm and not greater than 700 nm.

In some examples, the body 110 is tapered from a first end 112 to a second end 114. For example, FIG. 1B is a front view of the system 100, according to an example of the present disclosure. As shown in FIG. 1B, the width of the body 110 at the first end 112 is greater than the width of the body 110 at the second end 114. In some examples, the width of the body 110 does not decrease linearly from the first end 112 to the second end 114. As shown in FIG. 1B, in some examples, the body 110 is curved.

In some examples, a maximum width of the body 110 is greater than a maximum width of the hub 124. For example, each of the body 110 and the hub 124 include a circumference. In some examples, a ratio of a maximum circumference of the hub 124 to a maximum circumference of the body 110 is between 1 to 70 and 1 to 100. In some examples, the ratio of the maximum circumference of the hub 124 to the maximum circumference of the base 104 is between 1 to 70 and 1 to 100.

FIG. 1C is a bottom view of the system 100, according to one or more examples of the present disclosure. As shown in FIG. 1C, in some examples, a bottom side of the base 104 includes a switch 144. In some examples, the switch 144 controls at least one of an RPM of the fan 120 and a mode of the light component 160. For example, the switch 144 is used to turn the light component 160 from a “Flickering” mode to a “Steady State” mode. In some examples, the switch 144 powers the apparatus 102 on or off, which also powers the light component 160 and the fan 120 on or off. As shown in FIG. 1A, in some examples, the body 110 and/or the base 104 includes one or more indicators 158. In some examples, the indicator 158 is lit up to indicate that the apparatus 102 is turned on. In some examples, the indicator 158 is lit up to indicate that the apparatus 102 is connected via a wireless connection.

In some examples, the apparatus 102 is battery-powered. In other words, each of the motor 122 and the light component 160 are battery-powered. FIG. 1C shows a covering 142 of a battery receptacle. For example, the covering 142 is removed to insert AAA batteries into the battery receptacle, and the AAA batteries provide power to the light component 160 and the motor 122.

As shown in FIG. 1C, in some examples, the system 100 includes a handle 140 that is attached to the base 104. For example, the handle 140 is coupled to the base 104 on a side 174 of the base 104 that is opposite to the side 172 (shown in FIG. 1D) that the light component 160 is coupled to. In some examples, the handle 140 is rotatable about an axis 117 that is substantially perpendicular to the axis 116. In some examples, the axis 117 is coplanar with at least one side 174 of the base 104. As such, the handle 140 is configured to be rotated away from the base to help facilitate storage, hanging, and/or transporting of the system 100. Although not shown in FIG. 1C, in some examples, the base 104 includes a groove configured to receive the handle 140.

FIG. 1D is an exploded view of the system 100, according to examples of the present disclosure. As shown in FIG. 1D, in some examples, the system 100 includes a single light component 160. However, examples of the present disclosure are not so limited. In some examples, the system 100 includes two or more light sources 160 positioned within the body 110.

Although FIG. 1D shows the controller 108 within the base 104, examples of the present disclosure are not so limited. In some examples, the controller 108 is located on or within other portions of the apparatus 102.

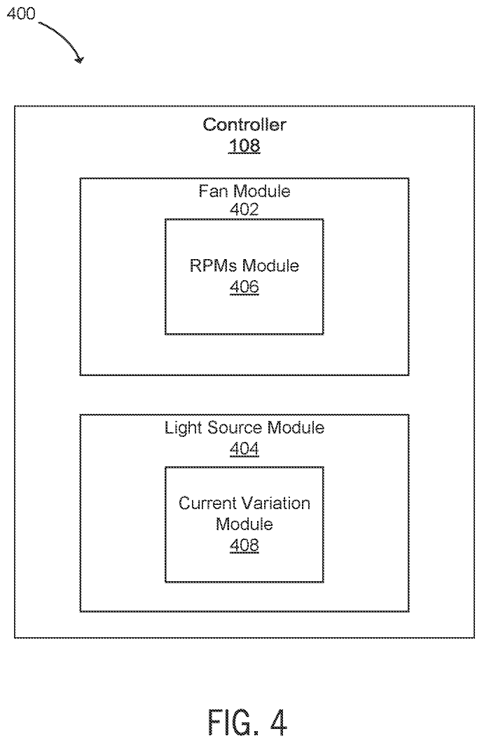

FIG. 4 is a schematic block diagram illustrating an example of an apparatus 400 for controlling the fan and/or light source control. In some examples, the apparatus 400 includes an example of a controller 108. In some embodiments, all or a portion of the apparatus 400 is implemented with hardware circuits. In other embodiments, all or a portion of the apparatus 400 is implemented using a programmable hardware device. In other embodiments, all or a portion of the apparatus 400 is implemented with executable code stored on computer readable storage media where the code is executable by a processor, such as a processor in the controller 108.

The apparatus 400, in some examples, includes one or more of a fan module 402, a light source module 404, an RPMs module 406, and a current variation module 408, which are described in more detail below.

The fan module 402 is configured to actuate a fan 120 to power on and/or power off. For example, the fan module 402 is configured to control the supply of power to the fan 120. In some examples, the fan module 402 includes an Light source module 404. The Light source module 404 is configured to adjust an RPM of the fan 120 by adjusting an RPM of the motor 122. For example, the Light source module 404 adjusts the RPMs based on user input.

The light source module 404 is configured to actuate a light component 160 to power on and/or power off. The light source module 404 includes a current variation module 408 that is configured to vary a supply of current to the light component 160 throughout an interval of time, creating a flickering effect.

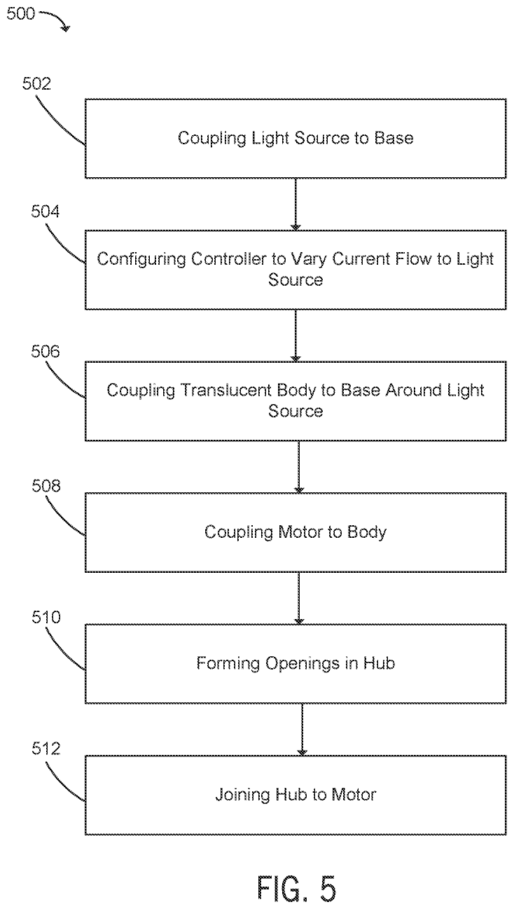

FIG. 5 is a schematic flow chart of a method 500 of manufacturing an apparatus for repelling insects (e.g., apparatus 102), according to one or more examples of the present disclosure. As shown in FIG. 5, the method 500 includes coupling 502 a number of light sources 164 to a base 104 (e.g., via the support 161). The method 500 includes configuring 504 a controller 108 to vary a current flow to each light source 164 of the number of light sources 164. The method 500 includes coupling 506 a translucent body 110 to the base 104 around the number of light sources 164 at a first end 112 of the translucent body 110. The method 500 includes coupling 508 a motor 122 to the body 110 at a second end 114 of the body opposite to the first end 112 such that the motor 122 is rotatable with respect to the body 110 about an axis 116 substantially perpendicular to the base 104.

The method 500 includes forming 510 a number of openings 126 configured to receive ends of fan blades 128 in a hub 124. In some examples, the method 500 includes coupling 512 the hub 124 to the motor 122. In some examples, the method 500 also includes inserting an end of a fan blade into each opening 126. In some examples, the method 500 additionally includes configuring the controller 108 to vary the RPMs of the motor 122. In some examples, coupling the number of light sources 164 to the base 104 includes coupling the number of light sources 164 to a support 161 such that the number of light sources 164 are arranged in rows 162. In some examples, coupling the number of light sources 164 to the base 104 includes coupling the support 161 to the base 104.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein a plurality of particular features does not necessarily mean every particular feature of an entire set or class of the particular features.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

What is claimed is:

1. An insect repellant apparatus, comprising:
a base;
a number of light sources coupled to the base;
a controller configured to vary a current flow to each light source of the number of light sources;
a translucent body coupled to the base at a first end of the body and shaped to fit around the number of light sources;
a motor coupled to the body at a second end of the body opposite to the first end of the body and rotatable with respect to the body; and
a hub coupled to the motor and comprising a number of openings configured to receive ends of blades.

2. The apparatus of claim 1, wherein:
the number of light sources comprise rows of light sources; and
the controller varying the current flow to the number of light sources comprises providing a first level of current flow to a first row of the rows and providing a second level of current flow different from the first level to a second row of the rows.

3. The apparatus of claim 2, wherein the motor is configured to rotate simultaneously with the number of light sources emitting light.

4. The apparatus of claim 2, wherein the controller is further configured to vary the current flow cyclically.

5. The apparatus of claim 1, wherein the controller is further configured to adjust a rotations per minute (“RPM”) of the hub via the motor.

6. The apparatus of claim 1, wherein each light source of the number of light sources is configured to emit light having a wavelength of not less than 560 nanometers (“nm”) and not greater than 700 nm.

7. The apparatus of claim 1, wherein a light source of the number of light sources comprises a light-emitting diode (“LED”).

8. The apparatus of claim 1, wherein the body has a first width at the first end and a second width at the second end that is less than the first width.

9. The apparatus of claim 1, wherein the base comprises a self-balancing base.

10. The apparatus of claim 1, wherein each of the motor and the hub are rotatable with respect to the body about an axis that is substantially perpendicular to the base.

11. The apparatus of claim 1, wherein the motor is configured to rotate at an RPM of not less than 270 and not greater than 1350.

12. A system, comprising:
a base;
a number of light sources coupled to the base;
a controller configured to vary current flow to each light source of the number of light sources;
a translucent body coupled to the base at a first end of the body and shaped to fit around the number of light sources;
a motor coupled to the body at a second end of the body opposite to the first end of the body and rotatable with respect to the body about an axis substantially perpendicular to the base;
a hub coupled to the motor and comprising a number of openings; and
a number of blades, each blade of the number of blades comprising a first end configured to be removably received by an opening of the number of openings.

13. The system of claim 12, each blade of the number of blades comprising a coating of holographic material.

14. The system of claim 12, each blade of the number of blades comprising:
a first section comprising the first end; and
a second section removably attachable to the first section at a second end of the first section opposite to the first end.

15. The system of claim 14, wherein the second section is removably attachable to the first section via one or more openings in the first section.

16. The system of claim 12, wherein the controller is further configured to cyclically vary the current flow over cycles of not less than 0.25 and not greater than 5 seconds in duration.

17. The system of claim 12, wherein a ratio of a maximum circumference of the hub to a maximum circumference of the base is between 1 to 70 and 1 to 100.

18. The system of claim 12, further comprising a handle attached to and configured to rotate about an axis coplanar with and a first side of the base opposite to a second side of the base, wherein the number of light sources are coupled to the second side of the base.

19. A method of manufacturing an insect repellant apparatus, comprising:
coupling a number of light sources to a base;
configuring a controller to vary a current flow to each light source of the number of light sources;
coupling a translucent body to the base around the number of light sources at a first end of the translucent body;
coupling a motor to the body at a second end of the body opposite to the first end of the body such that the motor is rotatable with respect to the body about an axis substantially perpendicular to the base;
forming a number of openings configured to receive ends of blades in a hub; and
coupling the hub to the motor.

20. The method of claim 19, wherein coupling the number of light sources to the base comprises coupling:
the number of light sources to a support such that the number of light sources are arranged in rows; and
the support to the base.
